(19) United States
(12) Patent Application Publication
(10) Pub. No.: US 2006/0258295 A1
(43) Pub. Date: Nov. 16, 2006

(54) Automatic network performance data collection and optimization

(75) Inventors: Tony W. Wong, Dallas, TX (US); Brad Hale, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/130,288

(22) Filed: May 16, 2005

(51) Int. Cl. H04B 17/00

(52) U.S. Cl. 455/67.13; 455/67.14

(57) ABSTRACT

A method for collecting communication system information from a communication system including a controller and one or more communication devices operating therein includes transmitting a request to the one or more communication devices requesting information regarding a quality of signal(s) received at the one or more communication devices along with geographical location information from the one or more communication devices, and transmitting automatically from the one or more communication devices the signal quality information along with the geographical location information to the controller. A communication device which can automatically provide signal quality and location information is also described, as well as a communication system that can collect signal quality and geographical location information from one or more communication devices operating within the communication system.

### FIELD OF THE INVENTION

This invention relates to wireless communications, and more specifically to a method and apparatus for providing automatic network performance data collection and optimization.

### BACKGROUND OF THE INVENTION

Wireless communication networks such as cellular telephone systems typically require periodic “drive testing” in order to perform radio frequency (RF) performance optimization of the network. Drive testing typically encompasses a team of technicians who drive around the cellular system geographical coverage area testing the RF coverage and other parameters of the system. The technicians usually drive in a specially equipped van taking different measurements. Periodic drive testing is typically conducted not only to maintain proper system adjustments, but also, for example, when a new cell or cell site is added, when there is a big change in traffic pattern in the system (e.g., due to a new highway), and/or the addition or relocation of the mobile switching center (MSC) as a few illustrative examples.

All the above mentioned factors and others demand that the system be drive tested since a sub-optimized communication network may have many revenue-impacting effects such as higher drop call rates which result in lower minutes of use (MOU) by system users, poor customer retention rates due to poor system performance and uneven traffic distribution caused by a network that is not optimized.

A typical drive-test will require a few technicians and/or RF engineers to drive around taking plots of RF signal levels, etc. From the result of the drive tests, optimization of the system is performed. Optimization can include adjustment of signal power levels for different cells, tilting of antennas on towers, adding antenna towers to improve coverage in certain heavy usage locations, etc. Drive-testing although beneficial is time consuming and requires a lot of manual work on the part of a group of technicians to perform the test properly.

### BRIEF DESCRIPTION OF THE DRAWINGS

FIG. 1 shows a diagram of a communication system in accordance with one embodiment of the invention.

FIG. 2 shows a block diagram of a communication device in accordance with an embodiment of the invention.

FIG. 3 shows a flowchart highlighting an automatic GPS/RSSI scheme in accordance with one embodiment of the invention.

### DETAILED DESCRIPTION OF THE PREFERRED EMBODIMENTS

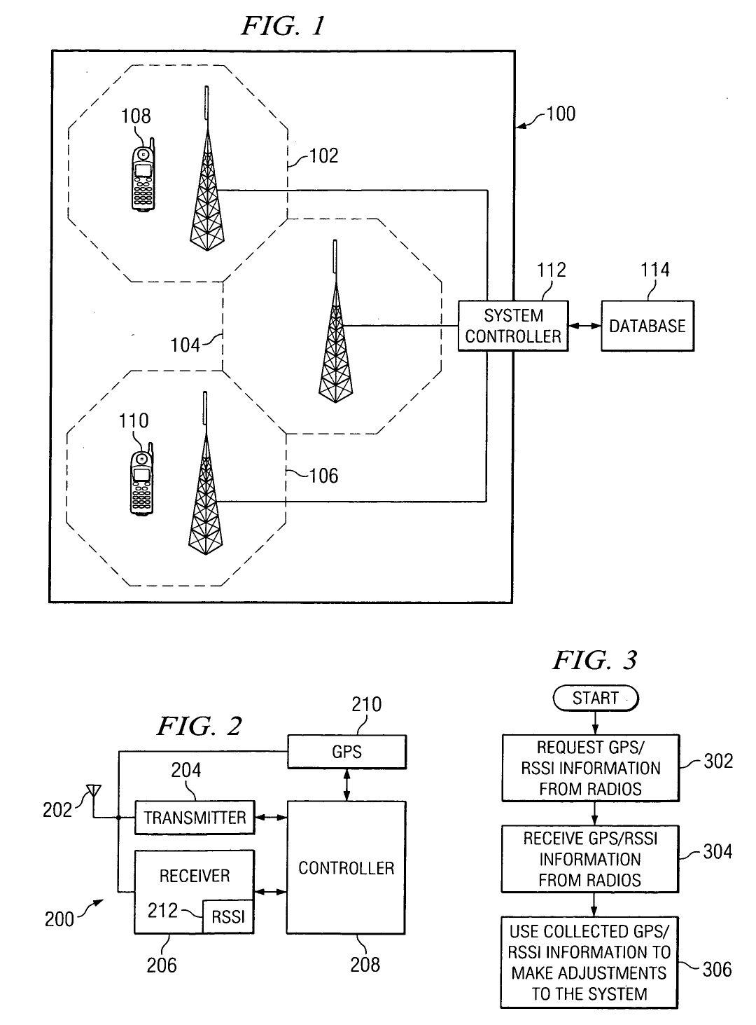

In accordance with one embodiment of the invention, a communication network 100 such as that shown in FIG. 1, collects signal quality information such as received signal strength indicator (RSSI) from the communication devices 108, 110 operating within the network 100. In one embodiment, the communication devices 108, 110 are equipped with global positioning system (GPS) receivers as well as RSSI measurement circuitry or other circuitry and/or software that provides information on received signal quality. When queried by the communication network system controller 112 by the generation of a system performance request message sent to one or more of the communication devices 108, 110, the communication devices 108, 110 transmit a message back to the system controller 112 which includes information on the RSSI that was measured by the communication device and the communication device's GPS location information at the time of the RSSI measurement.

It should be noted that although in the described embodiment a GPS receiver is used to provide geographical location information, any type of geographical positioning technique can be used to provide communication device position/location information. As illustrative examples, other geographical positioning techniques that can be used in the present invention can include Galileo, Time Difference of Arrival (TDOA), WiFi-positioning location methods, Loran-C, triangulation, etc.

Information received at the system controller 112 can be stored in a database 114. The RSSI/GPS information stored in the database 114 can then be analyzed in order to perform network optimization. The analysis of the information can be performed for example using mapping software that generates RF coverage plots, etc.

The system controller 112 or another system component can interrogate the communication devices 108, 110 periodically in order to take multiple measurements at various locations in the network 100. This interrogation can occur either during a long period of time (e.g., over different days) or over a short period of time (e.g., over a few minutes). Although the device collecting the information is referred to as a system controller or controller, it can comprise any system device that can generate a message to one or more of the communication devices 108, 110 requesting the system performance data (e.g., quality of signals transmitted to the communication devices 108, 110, etc.).

Using the RSSI information along with the GPS location information where the RSSI measurement was taken allows the communication network to draw detailed RF plots over most of the network 100. The RF plots will allow for appropriate actions to be taken in order to optimize the communication network. As illustrative examples, these actions can include but are not limited to, increasing/decreasing the RF power levels on one or more cell sites, adjusting antenna angles, adding a new cell site in heavily congested areas, etc. By automatically querying one or more of the communication devices operating within the communication network 100 a lot of useful system information can be gathered in a short period of time.

In order to reduce the effect on the system's performance, the automatic querying of the communication devices 108, 110 can occur during designated periods of time, during certain days/nights, groups of communication devices can be done during certain periods of time, etc. In some networks 100 where thousands of communication devices are operating within the network, a lot of system optimization information can be gathered without having to use manual drive-tests as in the prior art.

Referring now to FIG. 2, there is shown a block diagram of a communication device 200 in accordance with an embodiment of the invention. Communication device 200 can be a cellular telephone such as communication devices 108, 110 or other type of wireless communication device. Communication device 200 includes an antenna 202 selectively coupled to a transmitter 204, a receiver 206 and a GPS receiver 210. The overall operation of the communication device is controlled by a controller 208. Controller 208 can be a microcontroller, microprocessor, digital signal processor (DSP) or other control circuitry and/or software.

Communication device 200 further includes a global positioning system (GPS) receiver 210 which can be located separately from receiver 206 or integrated as part of receiver 206. Receiver 206 further includes a relative signal strength indicator (RSSI) circuit that can measure the signal strength of a received signal at communication 200. The RSSI circuit 212 can take anyone of a number of well known forms, for example hardware, software, firmware or a combination of these. In accordance with one embodiment of the invention, when communication device 200 receives a signal from system controller 112 requesting that a signal quality measurement (e.g., RSSI, etc.) be taken, the controller 208 requests the RSSI information from RSSI circuit 212 as well as the GPS location information from GPS receiver 210. The controller 208 can then cause transmitter 204 to send a message to the system controller 112 which includes the RSSI information and the GPS information were the RSSI measurement was taken. All of the above can be performed automatically without the user of the communication device 200 knowing that the measurement information is being sent to the system controller 112.

Referring now to FIG. 3, there is shown a flowchart highlighting some of the actions taken in accordance with one embodiment of the present invention. In 302, the system controller 112 or other component request RSSI/GPS information from one or more of the communication devices 108, 110 operating within the communication network 100. In 304, the system controller 112 receives the RSSI/GPS information from the radios and stores the information in the database 114. In 306, the collected RSSI/GPS information is analyzed using one of a number of tools such as a RF power mapping tool that maps the measured RSSI levels throughout the system. In an alternate embodiment, the information is averaged over certain geographical areas of the system in order to collect an aggregate measurement and speed up the system adjustment process.

In another embodiment, the system can automatically adjust (raise/lower) cell site power levels based on the collected information. An output such as a print out can also be generated which informs service crews/ RF engineering team of the need for example of adjusting the antenna angles on some of the antenna towers. Other embodiments may let the system know that a certain number of users were in a certain geographical area within the communication network 100 during a given period of time. If a predetermined number of users are located in a certain system coverage area as determined by the GPS information, the output information generated may let the system know that another cell site may be needed in the area, or the geographical area covered by certain cell sites may need to be adjusted.

The number of different adjustments or optimization performed based on the collected information can be many. The level of automation of the adjustments will also depend if the adjustments can be done by the system itself without human intervention (e.g., adjust power levels) or may require some type of manual intervention (e.g., technician needed to adjust antenna pattern). The system can also be manually overwritten if required, if for example, there is an immediate need of collecting system information at a certain period of time (e.g., after a new cell site has been added). Other system uses can include, determining if there is any RSSI degradation during certain times of the day, etc. The number of times a particular communication device or devices are queried for RSSI information can be changed depending on the information collection requirements of the communication network administrator.

Although RSSI has been discussed, other received parameters such as bit-error-rate (BER) or other measurements that can be taken by the communication devices 108, 110 can also be collected in addition to or instead of the RSSI information.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for collecting communication system information from a communication system including a controller and one or more communication devices operating therein, the method comprising:
transmitting a request to the one or more communication devices requesting information regarding a quality of signal(s) received at the one or more communication devices along with geographical location information from the one or more communication devices; and
transmitting automatically from the one or more communication devices the signal quality information along with the geographical location information to the controller.

2. A method as defined in claim 1, wherein the quality of signal(s) received comprises the received signal strength of the signal(s) received at the one or more communication devices.

3. A method as defined in claim 1, wherein the quality of signal(s) received at the one or more communication devices comprises the bit-error-rate (BER) of the received signals.

4. A method as defined in claim 2, wherein the geographical location information comprises GPS information.

5. A method as defined in claim 1, further comprising:
generating a plot from the received signal quality and geographical information collected from the one or more communication devices.

6. A method as defined in claim 1, further comprising:
making an adjustment to the communication system based on the collected signal quality information and geographical location information.

7. A communication device, comprising:
a receiver for receiving a signal;
signal quality measurement means for measuring the quality of the received signal;
a geographical positioning means for determining the geographical location of the communication device; and
a controller in response to receiving a request for a quality measurement and location information causes the signal quality measurement means to measure the quality of the received signal and the geographical positioning means to determine the geographical location of the communication device.

8. A communication device as defined in claim 7, wherein the signal quality measurement means comprises means for measuring relative signal strength.

9. A communication device as defined in claim 7, wherein the signal quality measurement means comprises means for measuring bit error rate (BER).

10. A communication device as defined in claim 7, further comprising:
a transmitter means for transmitting information signals.

11. A communication device as defined in claim 10, wherein the controller causes the transmitter to transmit information on the quality of the received signal and the geographical location information.

12. A communication device as defined in claim 11, wherein the information on the quality of the received signal and the geographical location information are transmitted to a system controller that collects the information for use in making adjustments to a communication system the communication device is operating in.

13. A communication device as defined in claim 11, wherein the transmitter automatically transmits the information regarding the quality of the received signal and the geographical location information without intervention by the communication device user.

14. A communication system, comprising:
a communication device;
a controller; and
in response to the controller having a system performance request message sent to the communication device, the communication device automatically transmits back to the controller information regarding quality of signal(s) received by the communication device and geographical location information of the communication device.

15. A communication system as defined in claim 14, wherein the communication device further includes a geographical positioning receiver.

16. A communication system as defined in claim 14, wherein the communication device further includes hardware and/or software for measuring the signal quality of received signals.

17. A communication system as defined in claim 14, further comprising:
a database for storing the received signal quality and geographical location information transmitted by the communication device.

18. A communication system as defined in claim 17, wherein the system controller uses the received signal quality and geographical location information to make an adjustment to the communication system.

19. A communication system as defined in claim 18, wherein the adjustment to the communication system the controller makes is adjusting the power level of signals transmitted to the one or more communication devices.

20. A communication system as defined in claim 16, wherein the signal quality that is measured by the communication device is the received signal strength of the received signals.
